(19) United States
(12) Patent Application Publication
(10) Pub. No.: US 2025/0103959 A1
(43) Pub. Date: Mar. 27, 2025

(54) METHOD FOR OPTIMIZING PERFORMANCE OF MODEL TRAINING DEVICE, ELECTRONIC DEVICE AND STORAGE MEDIUM

(71) Applicant: Beijing Baidu Netcom Science Technology Co., Ltd., Beijing (CN)

(72) Inventors: Liang Shen, Beijing (CN); Dianhai Yu, Beijing (CN); Weibao Gong, Beijing (CN); Jinle Zeng, Beijing (CN); Haifeng Wang, Beijing (CN)

(73) Assignee: Beijing Baidu Netcom Science Technology Co., Ltd., Beijing (CN)

(21) Appl. No.: 18/885,339

(22) Filed: Sep. 13, 2024

(30) Foreign Application Priority Data
Sep. 22, 2023 (CN) 202311236843.7

(51) Int. Cl. G06N 20/00

(52) U.S. Cl. CPC G06N 20/00

(57) ABSTRACT

Provided is a performance optimization method for a model training device, an electronic device, and a storage medium, relating to the fields of deep learning, large model training, and distributed parallel strategies. The method includes: determining communication timing of a current model training device with respect to a target model block at a target sorting position, so as to be able to perform synchronously collective communication with other model training devices of a plurality of model training devices with respect to model blocks at the target sorting position; and performing the collective communication on a backward gradient of the target model block at the communication timing.

### CROSS-REFERENCE TO RELATED APPLICATIONS

The present application claims the priority from Chinese Patent Application No.202311236843.7, filed with the Chinese Patent Office on Sep. 22, 2023, the content of which is hereby incorporated herein by reference in its entirety.

### TECHNICAL FIELD

The present disclosure relates to the field of artificial intelligence technology, in particular, to the fields of deep learning, large model training, distributed parallel strategies, and other technologies.

### BACKGROUND

A large model refers to a machine learning model with a large amount of parameters and complex structures. The large model may handle massive amounts of data, thereby improving accuracy and generalization ability of a machine learning model. The large model has higher complexity and greater flexibility, and may handle more complex problems. The large model has more parameters and more complex structures, which can more accurately express data distribution and learn more complex features, thereby improving accuracy and performance of the model.

The large model has a wider range of application scenarios and higher performance abilities. However, the large model requires processing large amounts of data and parameters, has longer training and inference time, and consumes more calculation resources.

### SUMMARY

The present disclosure provides performance optimization method and apparatus of a model training device, and a device.

According to an aspect of the present disclosure, a performance optimization method for a model training device is provided, which includes:
determining communication timing of a current model training device with respect to a target model block at a target sorting position, so as to be able to perform synchronously collective communication with other model training devices of a plurality of model training devices with respect to model blocks at the target sorting position, where the current model training device is any one training device of the plurality of model training devices, the plurality of model training devices is used for training a same target model, the target model is divided into a plurality of model stages, each of the plurality of model stages includes a plurality of model blocks arranged in sequence, and during a process of training the target model by using a distributed parallelism strategy, bubbles are generated due to increased calculation time of the model training devices caused by communication operations; and
performing the collective communication on a backward gradient of the target model block at the communication timing.

According to another aspect of the present disclosure, a performance optimization apparatus for a model training device is provided, which includes:
a determining module configured to determine communication timing of a current model training device with respect to a target model block at a target sorting position, so as to be able to perform synchronously collective communication with other model training devices of a plurality of model training devices with respect to model blocks at the target sorting position, where the current model training device is any one training device of the plurality of model training devices; the plurality of model training devices is used for training the same target model; the target model is divided into a plurality of model stages, and each of the plurality of model stages includes a plurality of model blocks arranged in sequence; and during a process of training the target model by using a distributed parallelism strategy, bubbles are generated due to increased calculation time of the model training devices caused by communication operations; and
a performing module configured to perform the collective communication on a backward gradient of the target model block at the communication timing.

According to another aspect of the present disclosure, an electronic device is provided, which includes:
at least one processor; and
a memory connected in communication with the at least one processor;
the memory stores an instruction executable by the at least one processor, and the instruction, when executed by the at least one processor, enables the at least one processor to execute the method of any embodiment in the present disclosure.

According to another aspect of the present disclosure, a non-transitory computer-readable storage medium storing a computer instruction thereon is provided, where the computer instruction is used to cause a computer to execute the method of any embodiment in the present disclosure.

According to another aspect of the present disclosure, a computer program product is provided, which includes a computer program, the computer program, when executed by a processor, implements the method of any embodiment in the present disclosure.

In the embodiments of the present disclosure, in the plurality of model training devices of distributed training of the target model, on a basis of using data parallelism in combination of a pipeline parallelism strategy with a 1F1B interleaved scheduling manner, by implementing synchronous communication among the plurality of model training devices, a bubble rate may be effectively reduced and performances of the model training devices may be improved.

It should be understood that contents described in this part is not intended to identify key or important features of the embodiments of the present disclosure, nor is it intended to limit the scope of the present disclosure. The other features of the present disclosure are made easy to understand by the following description.

### BRIEF DESCRIPTION OF THE DRAWINGS

Accompanying drawings are provided for a better understanding of the present scheme and do not constitute a limitation of the present disclosure, in which:

FIG. 1 is a flow diagram of a performance optimization method for a model training device according to an embodiment of the present disclosure;

FIG. 2 is a timing diagram of a model training process provided according to an embodiment of the present disclosure;

FIG. 3 is a timing diagram of another model training process provided according to another embodiment of the present disclosure;

FIG. 4 is a timing diagram of yet another model training process provided according to another embodiment of the present disclosure;

FIG. 5 is a structural diagram of a performance optimization apparatus for a model training device according to an embodiment of the present disclosure; and

FIG. 6 is a block diagram of an electronic device for achieving a performance optimization method of a model training device according to an embodiment of the present disclosure.

### DETAILED DESCRIPTION

Hereinafter, explanation of exemplary embodiments of the present disclosure will be made in conjunction with the accompanying drawings, which includes various details of the embodiments of the present disclosure to facilitate understanding and should be considered merely exemplary. Therefore, those having ordinary skill in the art should recognize that various changes and modifications may be made to the embodiments described herein without departing from the scope of the present disclosure. Similarly, for clarity and conciseness, descriptions of well-known functions and structures are omitted in the following descriptions.

In addition, terms “first” and “second” are only used for a descriptive purpose and cannot be understood as indicating or implying relative importance or implying an amount of indicated technical features. Therefore, features limited by “first” and “second” may explicitly or implicitly include one or more of these features. In the description of the present disclosure, unless otherwise specified, the meaning of “a plurality of” refers to two or more.

With advent of the big data era, an amount of data generated in people's lives continues to increase. In order to process massive amounts of data, solve various complex problems, and meet requirements to high efficiency of users for deep learning tasks, an excellent model is often obtained through a complex training process. In order to achieve better model training, distributed parallel training methods are commonly used to accelerate training. In related technologies, two manners including data parallelism and pipeline parallelism are usually used for implementation. The following will introduce the above two manners respectively.

The principle of the data parallelism is that a dataset is divided into a plurality of parts, and each model training device stores complete training parameters and processes one part of the dataset to accelerate a model training process.

The pipeline parallelism is a type of model parallelism, which works by splitting a model into different training devices to reduce memory consumption of a single model training device, and making adjacent devices transmit data through communication links, to achieve large-scale model training.

However, the data parallelism requires a memory of the model training device to accommodate a complete model, and thus has poor scalability. In addition, when the pipeline parallelism splits the model, it does not comprehensively consider load balancing of the model training devices and overall communication time. Training by using the pipeline parallelism separately does not fully utilize the model training devices, and efficiency of model training still needs to be improved.

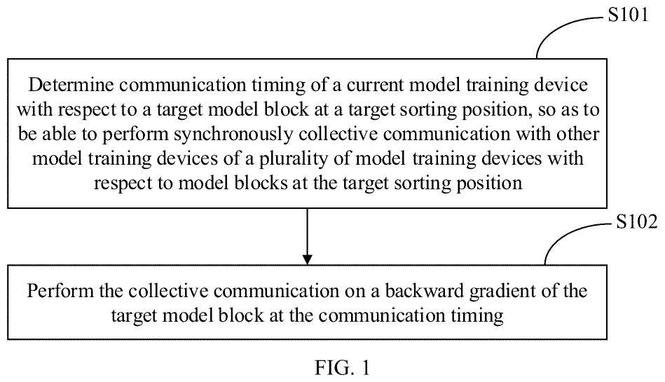

Therefore, in related technologies, a data parallelism strategy and a pipeline parallelism strategy may be used to train a large model. However, in a process of combining backward gradient communication, an overall bubble rate still needs to be improved. Bubbles may lead to wastage of calculation resources by the model training devices. In order to improve an effect of model training, so as to enhance performance of a large-scale model training device, the present application proposes a performance optimization method for a model training device. The performance optimization method combines the data parallelism and the pipeline parallelism to achieve synchronous communication, thereby improving an overlap rate of calculations of the model training devices and reducing the overall bubble rate, and thereby improving performances of the model training devices. A specific implementation process of the performance optimization method for the model training device is shown in FIG. 1 and includes following steps.

In step S101, communication timing of a current model training device with respect to a target model block at a target sorting position is determined, so as to be able to perform synchronously collective communication with other model training devices of a plurality of model training devices with respect to model blocks at the target sorting position.

Where the current model training device is any one training device of the plurality of model training devices. The plurality of model training devices is used for training the same target model. The target model is divided into a plurality of model stages, and each of the plurality of model stages includes a plurality of model blocks arranged in sequence. During a process of training the target model by using a distributed parallelism strategy, bubbles are generated due to increased calculation time of the model training devices caused by communication operations.

In step S102, the collective communication is performed on a backward gradient of the target model block at the communication timing.

In the embodiments of the present disclosure, the target model is a large model, which refers to a machine learning model with a large scale of parameters and complexity. In the field of deep learning, large models typically refer to neural network models with millions to billions of parameters. These models require a large amount of calculation resources and storage space for training and storing, and often require distributed calculation and special hardware acceleration techniques.

Design and training of the large model aim to provide more powerful and accurate model performance to cope with more complex and larger datasets or tasks. The large model is usually able to learn more subtle patterns and rules, has stronger generalization and expression abilities.

In the embodiments of the present disclosure, parallel calculation abilities of the model training devices may be maximally utilized by making the communication timing of the plurality of model training devices consistent. The bubbles caused by communication may be reduced by controlling synchronous communication among the plurality of model training devices and arranging the communication timing reasonably, thereby decreasing the bubble rate, improving the overlap of the calculations, shorting calculation time-consuming, and increasing communication efficiency, and thus the performances of model training devices are improved.

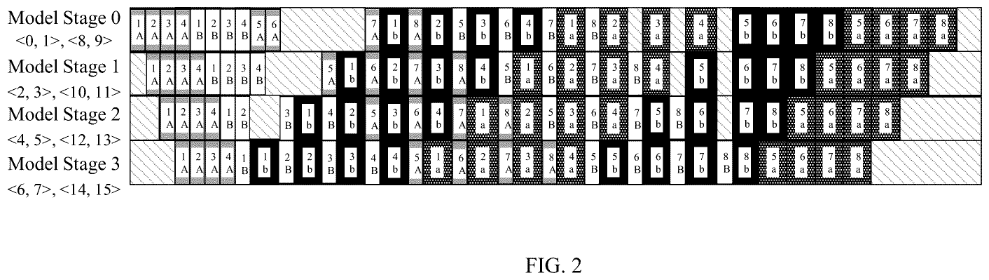

When the pipeline parallelism strategy is used for model training, the target model is divided into the plurality of model stages according to the pipeline parallelism strategy. For example, as shown in FIG. 2, the target model is divided into four model stages, namely Model Stage 0, Model Stage 1, Model Stage 2, and Model Stage 3. Each model stage is deployed to a one-to-one-corresponding model training device. Each model stage may be divided into the plurality of model blocks, each of the plurality of model blocks includes one neural network layer or a plurality of neural network layers. In a case of including the plurality of neural network layers, the plurality of neural network layers is continuous. For example, if the target model has neural network layers numbered 0-15 in sequence, the target model has a total of 16 neural network layers. If the 16 neural network layers are deployed to four model training devices for training, each model training device may deploy four neural network layers. The corresponding target model may be divided into the four model stages, with an assumption that each model stage is divided into two model blocks. As shown in FIG. 2, neural network layers numbered 0, 1, 8, and 9 are constructed into two model blocks, namely <0, 1> and <8, 9>, of the first model stage (i.e., Model Stage 0 in FIG. 2); neural network layers numbered 2, 3, 10, and 11 are constructed into two model blocks, namely <2, 3> and <10, 11>, of the second model stage (i.e., Model Stage 1 in FIG. 2); neural network layers numbered 4, 5, 12, and 13 are constructed into two model blocks, namely <4, 5> and <12, 13>, of the third model stage (i.e., Model Stage 2 in FIG. 2); neural network layers numbered 6, 7, 14, and 15 are constructed into two model blocks, namely <6, 7> and <14, 15>, of the fourth model stage (i.e., Model Stage 3 in FIG. 2).

Explanation is continuous to be made based on the model stages shown in FIG. 2. During training, the first model block of the first model stage is first used for performing forward calculation, after the forward calculation of the first model block of the first model stage is completed, the forward calculation of the first model block of the second model stage is performed, a calculation result is passed down sequentially until the forward calculation of the first model block of the fourth model stage is completed. Then it is started to perform the forward calculation of the second model block of the first model stage, a calculation result is passed down, after the forward calculation of the second model block of the fourth model stage is completed, it is started to alternate to perform backward calculation from the forward calculation. A result of the backward calculation passes up in sequence. Until the backward calculation of the first model block of the first model stage is completed, backward propagation of the 16 neural network layers is finished.

In the embodiments of the present disclosure, the target model is trained by using the data parallelism strategy combined with the pipeline parallelism strategy having a 1F1B interleaved scheduling manner, and is divided into the plurality of model stages according to the pipeline parallelism strategy. Each model stage is assigned to a corresponding model training device for training. In the data parallelism strategy, each mini batch of training data is divided into a plurality of micro batches. As shown in FIG. 2, the training data is divided into a plurality of mini batches, with each mini batch being divided into 4 micro batches. In FIG. 2, the same number refers to the same micro batch. A represents performing the forward calculation on the first model block of each model stage, and B represents performing the forward calculation on the second model block of each model stage. b represents performing backward gradient calculation on the second model block of each model stage. a represents performing backward gradient calculation on the first model block of each model stage. Each micro batch goes through processing of each model block in sequence, which is equivalent to completing a forward processing operation in a sequence of the neural network layers of the target model. In a case of backward, an update order of the model blocks is exactly opposite to a forward process.

For example, the model dividing manner shown of FIG. 2 is continuously taken as an example. In the forward process in the timing diagram of FIG. 2, the forward calculation of the first model block of each model stage is represented by gray color filled rectangular boxes, and the forward calculation of the second model block of each model stage is represented by white color filled rectangular boxes. In a backward process of FIG. 2, the backward calculation of the second model block of each model stage is represented by black color filled rectangular boxes, and the backward calculation of the first model block of each model stage is represented by dot texture filled rectangular boxes (all of which contain the character a). A forward process of a micro batch is as follows: first, after processing by the first model block <0, 1> of Model Stage 0, a processing result is passed to the first model block <2, 3> of Model Stage 1, then the processing result is passed to the first model block <4, 5> of Model Stage 2, then the processing result is passed to the first model block <6, 7> of Model Stage 3, then the processing result is sequentially passed to the second model block <8, 9> of Model Stage 0, then the processing result is passed to the second model block <10, 11> of Model Stage 1, then the processing result is passed to the second model block <12, 13> of Model Stage 2, and finally the processing result is passed to the second model block <14, 15> of Model Stage 3. Thus, a forward propagation process of the entire 16 neural network layers is completed through coordination of different model stages and different models. A processing sequence of the backward process is exactly opposite to that of the forward process. For example, referring to the black color filled rectangular boxes containing the character b in FIG. 2, the backward calculation of the second model block of Model Stage 3 is first performed, then the backward calculation of the second model block of Model Stage 2 is performed, then the backward calculation of the second model block of Model Stage 1 is performed, and then the backward calculation of the second model block of Model Stage 0 is performed. After the backward calculations of the second model blocks are completed, refer to the dot texture filled rectangular boxes containing the character a in FIG. 2, the backward calculations of the first model blocks of Model Stage 3, Model Stage 2, Model Stage 1, and Model Stage 0 are performed in sequence.

In the embodiments of the present disclosure, the 1F1B interleaved scheduling manner is adopted, so that each model training device may alternatively perform the forward and backward processes. In the 1F1B interleaved scheduling manner, each device may perform calculation on subsets (that is, the model blocks) of the plurality of layers, instead of a set of continuous layers.

A 1F1B mode is a way of alternatively performing the forward and backward calculations. In the 1F1B mode, the forward and backward calculations are performed alternately, which may release unnecessary intermediate variables timely.

In the 1F1B interleaved scheduling manner, the plurality of mini batches is used to train the target model, and each mini batch is divided into the plurality of micro batches. A dependency relationship of calculation tasks for data of the plurality of micro batches is built on the same model training device. For example, after each model training device performs the forward calculation on data of the i-th micro batch, the backward calculation is directly performed on a forward calculation result of the i-th micro batch, until a target number of times of backward calculations is completed, and then the collective communication is performed, so as to update model parameters based on a gradient obtained from the backward calculations.

As shown in FIG. 2, the gray color filled rectangular boxes containing the character A and the white color filled rectangular boxes containing the character B are forward calculation processes, the black color filled rectangular boxes are backward calculation processes with respect for the white color filled rectangular boxes, and the dot texture filled rectangular boxes containing the character a are backward calculation processes with respect to the gray color filled rectangular boxes. Each mini batch is divided into 4 micro batches. The backward calculation processes are introduced by taking the second model blocks as an example. In FIG. 2, after Model Stage 3 completes the forward calculation, the second model block of Model Stage 0 performs the backward gradient calculation on the second model block <14, 15> of Model Stage 3 (such as 1b in Model Stage 3 in FIG. 2), a calculation result is passed to the model training device of Model Stage 2, which performs the backward gradient calculation on the second model block <12, 13> of Model Stage 2 (such as 1b in Model Stage 2 in FIG. 2), and then passes a processing result to the model training device of Model Stage 1. The model training device of Model Stage 1performs the backward gradient calculation on the second model block <10, 11>, and then passes the processing result to the model training device of Model Stage 0. The model training device of Model Stage 0 performs the backward gradient calculation on the second model block <8, 9>, then the processing result is sequentially passed to Model Stage 3 to complete the backward gradient calculation on the first model block <6, 7> of Model Stage 3, then the processing result is passed to Model Stage 2 to complete the backward gradient calculation on the first model block <4, 5> of Model Stage 2. Then, the processing result is passed to Model Stage 1 to complete the backward gradient calculation on the first model block <2, 3> of Model Stage 1, then the processing result is passed to Model Stage 0 to complete the backward gradient calculation on the first model block <0, 1> of Model Stage 0. Thus, a backward propagation process of the entire 16 neural network layers is completed through the coordination of different model stages and different models.

In the embodiments of the present disclosure, the pipeline parallelism strategy using the 1F1B interleaved scheduling manner is combined with the data parallelism strategy for distributed training, and alternatively performing the forward and backward calculations, so that unnecessary intermediate variables may be freed up and consumption of memory resources may be reduced. In addition, by using the plurality of mini batches to train the model, with each mini batch being divided into the plurality of micro batches, memory efficiency may be increased and model training speed may be accelerated. When a training dataset is large, loading an entire batch into memory at once may lead to insufficient memory, by using the plurality of mini batches to train the model may load and process one by one, thereby effectively utilizing the memory resources. By dividing the plurality of mini batches into the plurality of micro batches, parallel processing may be achieved, thereby accelerating the training speed.

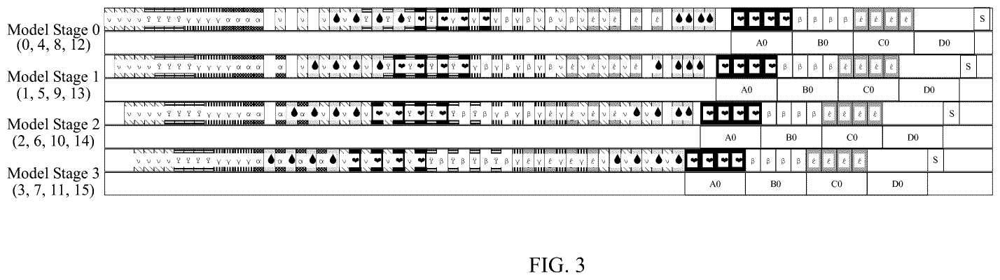

In other examples, each model block may not only include the plurality of neural network layers, but also include one neural network layer. For example, in FIG. 3, the corresponding target model is divided into four model stages, and each of the four model stages includes four model blocks arranged in sequence. Each model training device performs calculations on the four model blocks, and each of the four model blocks has one neural network layer. As shown in FIG. 3, Model Stage 0 has four neural network layers numbered 0, 4, 8, and 12, which are both model blocks and neural network layers; Model Stage 1 has four neural network layers numbered 1, 5, 9, and 13, which are both model blocks and neural network layers; Model Stage 2 has four neural network layers numbered 2, 6, 10, and 14, which are both model blocks and neural network layers; and Model Stage 3 has four neural network layers numbered 3, 7, 11, and 15, which are both model blocks and neural network layers. The first model block 0 of Model Stage 0 represents performing the forward process by using the rectangular boxes with diagonal texture and embedded with pentagram shapes, and a processing result is sequentially passed down to the first model block 3 of Model Stage 3. Then the processing result is sequentially passed to the second model block 4 of Model Stage 0. In FIG. 3, the second model block represents the forward process by using the rectangular boxes with vertical stripes and embedded in square shapes, and sequentially passes the result down to the second model block 7 in Model Stage 3. Then the processing result is sequentially passed to the third model block 8 of Model Stage 0, the third model block represents the forward process by using the rectangular boxes with horizontal stripes and embedded with circular shapes, and sequentially passes the result down to the third model block 11 in Model Stage 3. Then the processing result is sequentially passed to the fourth model block 12 of Model Stage 0, the fourth model block represents the forward process by using the rectangular boxes with dotted stripes and embedded with arrow shapes, and sequentially passes the result down to the fourth model block 15 in Model Stage 3. After the forward propagation process is completed, the backward propagation process begins, and the backward propagation process has a sequence exactly opposite to a sequence of updating model blocks during the forward propagation.

Through this solution, each model training device in the pipeline is assigned a plurality of pipeline stages, resulting in less calculation for each pipeline stage.

It should be noted that the number of the model stages divided from the target model, as well as the number of model blocks contained in each model stage and the number of neural network layers contained in each model block, may be determined according to actual needs, which is not limited in the embodiments of the present disclosure.

Both FIG. 2 and FIG. 3 may be understood as timing diagrams of the model training process. The horizontal axis in FIG. 2 and FIG. 3 represents time, and vertically stacked rectangular boxes represent types of operations performed at corresponding time. Where the types of the operations are divided into two parts, including calculation and communication. As shown in FIG. 3, for each model training device, upper parts containing densely rectangular boxes are the computational parts. In FIG. 3, rectangular boxes with diagonal texture and embedded with pentagram shapes, rectangular boxes with vertical stripes and embedded in square shapes, rectangular boxes with horizontal stripes and embedded with circular shapes, and rectangular boxes with dotted stripes and embedded with arrow shapes represent forward calculation parts. Rectangular boxes with light gray texture and embedded with droplet shapes, rectangular boxes with black texture and embedded with heart shapes, rectangular boxes with white texture and embedded with rhombus shapes, and rectangular boxes with deep grey texture and embedded with triangle shapes represent backward calculation parts. Lower parts containing rectangular boxes starting with the character A is the communication parts.

Both FIG. 2 and FIG. 3 demonstrate the 1F1B interleaved scheduling manner. However, during a scheduling process based on the 1F1B mode, each model training device adopts asynchronous communication, that is, backward communication processes of model blocks at the same sorting position are dispersed and completed at different time. The asynchronous communication will result in generation of redundant bubbles during calculations, and thus calculation time is increased, and a “cumulative effect” is occurred, leading to an increase in an end-to-end bubble rate. As shown in FIG. 3, communications of each model stage (such as A0, B0, C0, and D0) are dispersed at different time to be performed. During the backward propagation process, bubbles between the rectangular boxes with light gray texture and embedded with droplet shapes and the rectangular boxes with black texture and embedded with heart shapes become larger and larger, the “cumulative effect” is occurred, that is, the bubbles are accumulated, leading to an increase of the calculation time and the increase of the end-to-end bubble rate.

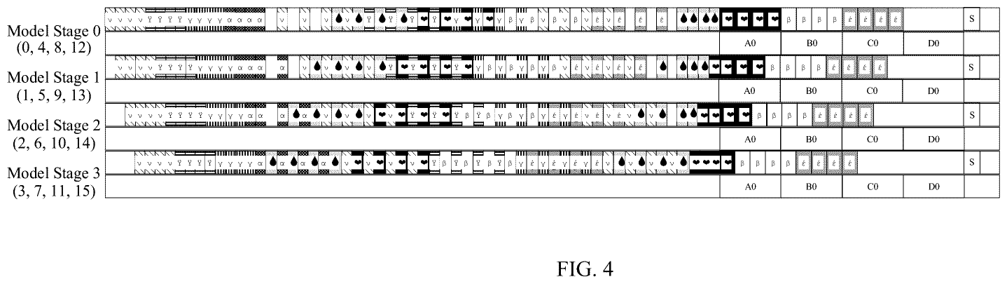

In order to eliminate the “cumulative effect”, in the embodiments of the present disclosure, it is necessary to control all model training devices participating in pipeline calculations to synchronously perform data parallel gradient communication in the 1F1B interleaved scheduling of the pipeline parallelism strategy. As shown in FIG. 4, each model stage communicates at the same communication timing. As the result of the backward calculation passes up, compared to FIG. 3, the bubbles between the rectangular boxes with light gray texture and embedded with droplet shapes and the rectangular boxes with black texture and embedded with heart shapes become smaller and smaller. The bubbles during the entire model training process are significantly reduced, resulting in a decrease in the calculation time during the backward propagation process. The efficiency of model training is increased while the bubble rate is reduced, thereby improving the performances of the entire model training devices.

In the embodiments of the present disclosure, there is two manners of determining the communication timing of the current model training device with respect to the target model block at the target sorting position, which include follows.

In the first manner, each model training device may determine the communication timing of the collective communication for each model block through a communication manner.

In order to achieve the synchronously collective communication to eliminate the bubbles, in the embodiments of the present disclosure, the synchronous communication may be achieved through communication mechanisms among different model training devices. It may be implemented as: in response to receiving a synchronization message, determining a next calculation stage as the communication timing of the target model block, the synchronization message is sent by the model training device of the first model stage among the plurality of model stages with respect to the model blocks at the target sorting position.

It may be understood that the model training device of the first model stage may send the synchronization message after completing the backward gradient calculation for the model block at the target sorting position, so as to enable the plurality of model training devices to complete backward communication with respect to the model blocks at the same sorting position. For example, in FIG. 4, after the communication timing of Model Stage 0 is determined, the communication timing of Model Stages 1, 2, and 3 automatically shifts backwards by rank (calculation stage) steps to synchronize with the communication timing of Model Stage 0.

In the embodiments of the present disclosure, the plurality of model training stages corresponds to the first model stage of one model training device, enabling the plurality of model training devices to perform the synchronous communication, improving the overlap of the calculations, reducing the bubble rate, and enhancing the performances of the model training devices.

As shown in FIG. 4, in the first model stage, A0 is a part of performing the collective communication on a backward gradient of a model block numbered 12 whose sorting position is the 4th, and time when the collective communication starts is the communication timing. B0 is a part of performing the collective communication on a backward gradient of a model block numbered 8 whose sorting position is the 3rd. C0 is a part of performing the collective communication on a backward gradient of a model block numbered 4 whose sorting position is the 2nd. D0 is a part of performing the collective communication on a backward gradient of a model block numbered 0 whose sorting position is the 1st. It can be inferred that a sequence of collective communications is opposite to a sequence of the forward calculations of the model blocks. Therefore, it is same to parts of performing the collective communication on each target model block by Model Stages 1, 2, and 3. The target model block and its part of performing the collective communication may be corresponded one-to-one, and which will not be repeated in the present disclosure.

In the second manner, each model training device may independently determine the communication timing for the collective communication of each model block.

It may be implemented as: determining the next calculation stage as the communication timing of the target model block in a case of satisfying target constraint conditions. The target constraint conditions include followings.
1) A number of times of backward gradient calculations of the target model block by the current model training device is greater than or equal to a target number of times.
2) At the communication timing, the backward gradient calculations of a model block at the target sorting position in the first model stage of the plurality of model stages are completed.

As shown in FIG. 2, the first model stage is Model Stage 0, and the model blocks in the first model stage include two model blocks <0, 1> and <8, 9>. In Model Stage 0 of FIG. 2, gray color filled rectangular boxes and white color filled rectangular boxes are used to represent the forward calculation processes of model blocks at different sorting positions. The black color filled rectangular boxes represent the backward propagation processes for the white color filled rectangular boxes, and the dot texture filled rectangular boxes represent the backward propagation processes for the gray color filled rectangular boxes. As shown in FIG. 2, the completion of the calculation of the backward gradient of the model block at the target sorting position in the first model stage may be understood as that: taking the second model block as an example, calculations of backward gradients of the black color filled rectangular boxes of the same mini batch in Model Stage 0 are completed.

In the embodiments of the present disclosure, the synchronous communication is performed based on the target constraint conditions, and timing of the synchronous communication may be determined by each model training device independently, which may more accurately control the communication timing and ensure that communication occurs when needed. By accurately controlling the communication timing through the target constraint conditions, the calculation time may be shortened, the bubble rate may be reduced, and the performances of the model training devices may be improved, thereby enhancing the efficiency of model training.

In order to determine whether the target constraint conditions are satisfied, the following two implementations are given as examples in the embodiments of the present disclosure, which include followings.

A first manner of determining the target constraint conditions:

The determining of satisfying the target constraint conditions may be implemented as: determining a cumulative amount of the backward gradient to be synchronized for the target model block; and determining that the target model block satisfies the target constraint conditions, in a case where the cumulative amount is greater than or equal to the target number of times and it is determined that the model block at the target sorting position in the first model stage of the plurality of model stages can initiate the collective communication.

During implementation, a number of times of the backward calculations may be separately counted for each model block to determine whether the model block satisfies communication requirements.

Whether the model block at the target sorting position in the first model stage can initiate the collective communication may be estimated based on time required for the forward and backward calculations. A specific estimation manner may be achieved by using a neural network or by inferring based on computational complexity of a corresponding model block. A specific inferring process will not be elaborated in the present disclosure, and any inference method that can obtain the above solution may be used in the present disclosure.

In the embodiments of the present disclosure, gradient accumulation is a very simple calculation method. Using this method to count the number of times of the backward calculations may save calculation resources, reduce communication overhead, and improve the efficiency of model training.

A second manner of determining the target constraint conditions:

The determining of satisfying the target constraint conditions may be implemented as: obtaining an accumulation count of a number of times of the backward gradient calculations of the current model training device based on a default value; and determining that the target model block at the target sorting position satisfies the target constraint conditions, in a case where the accumulation count is greater than or equal to a target threshold and it is determined that an integer number of batches of the backward gradient calculations is completed based on the accumulation count.

The target threshold is determined based on the target number of times, so that the number of times of the backward gradient calculations by the current model training device with respect to the target model block is greater than or equal to the target number of times.

In the embodiments of the present disclosure, during a scheduling process, a model training device performs one backward gradient calculation for each micro batch and performs one gradient accumulation count. It is assumed the target number of times Acc_Step is 8, then the collective communication is performed in a case where the accumulation count of the backward gradient calculations that are completed with respect to one model block is greater than or equal to 8. In FIG. 2, with respect to the second model block of Model Stage 0, after performing of the backward gradient calculations shown as 1b, 2b, 3b and 4b of the black color filed rectangular boxes is completed, the following accumulated backward gradient calculations are with respect to the first model block, the collective communication with respect to the second model block may be performed when the number of times of the accumulated backward gradient calculations with respect to the second model block reaches 8, to ensure that the same model block can complete the number of times Acc_Step.

In the embodiments of the present disclosure, the determining of the communication timing of the target model block contained in the current model training device will not be affected by other model training devices. Each model training device may identify the communication timing of a result of the backward gradient calculation for each model block based on the constraint conditions, and interact the communication timing among devices. In addition, the entire process of accumulation counting and target preset determining is very simple calculation operations, which consumes less calculation resources that may be ignored, thereby improving the efficiency of model training.

In the embodiments of the present disclosure, different schemes for identifying the communication timing are provided based on different settings of the default value of the accumulation count. A setting manner of the default value is obtained through experimental inference based on the bubbles that need to be eliminated in the synchronous communication, and an inference process will not be repeated. An explanation of the communication timing under different settings of the default value is as follows.

(1) Identifying the communication timing of the collective communication based on a first default value

In the embodiments of the present disclosure, when the default value is empty, the target threshold is determined based on the number of times of the backward gradient calculations, the number of the model stages, and the number of the model blocks contained in each model stage.

For example, the default value is set to empty, the target threshold determined based on the number of times of the backward gradient calculations, the number of the model stages, and the number of the model blocks contained in each model stage is (Acc_Step//PP−1)*PP*VP. Where, Acc_Step represents the number of times of the backward gradient calculations; PP represents the number of the divided model stages; and VP represents the number of the model blocks included in each model stage;//represents rounding downwards.

In the embodiments of the present disclosure, setting the default value of number of times of the backward gradient calculation for the current model training device to empty may reduce memory usage. In addition, determining the target threshold based on the number of times of the backward gradient calculations, the number of the model stages, and the number of the model blocks contained in each model stage may enable the model training device to timely determine the communication timing, reduce the bubble rate, and improve the efficiency of model training.

In some embodiments, determining that the performing of the integer number of batches

of the backward gradient calculations is completed based on the accumulation count may be implemented as: determining a difference between the accumulation count with respect to a model stage serial number of the current model training device and the target threshold; in a case where the difference is exactly divided by the target number of times, it is determined that the performing of the integer number of batches of the backward gradient calculations has been completed.

For example, each model training device sets a counter, which is set to 0 when the default value is empty.

In the embodiments of the present disclosure, the model training device completes the training of the target model based on the 1F1B interleaved scheduling manner. When the 1F1B interleaved scheduling of VP is performed, one time backward calculation is performed, 1 is added to a count of the counter, then counter=counter+1.

When a counter of a rank-th calculation device (that is a rank-th model stage) satisfies following conditions, a (VP-(counter-rank−(Acc_Step//PP−1)*PP*VP)//PP)-th model block is determined as the target model block at the target sorting position, and communication is performed on this model block concurrently with a computation stream. Where rank is the model stage serial number of the current model training device.

A condition a in which counter is greater than (Acc_Step//PP−1)*PP*VP.

A condition b in which counter-rank−(Acc_Step//PP−1)*PP*VP may be exactly divided by Acc_Step.

The condition b is determining the difference between the accumulation count with respect to the model stage serial number of the current model training device and the target threshold. In a case where the difference is exactly divided by the target number of times, it is determined that the performing of the integer number of batches of the backward gradient calculations has been completed.

In the embodiments of the present disclosure, by combining the difference between the accumulation count and the model stage serial number of the current model training device with the target threshold, the communication timing of the target model block may be flexibly controlled based on the model stage serial number of the current model training device. By determining the completion of the integer number of batches of the backward gradient calculations, the process of model training can be better controlled, thereby saving memory space usage and improving the efficiency of model training.

For example, as shown in FIG. 4, PP is 4, VP is 4, Acc_Step is set to 8, that is the target model is divided into 4 model stages, each mini batch is divided into 4 micro batches, the accumulation count of the backward gradient is 8. In a case where the default value is empty, counter=0, and the target threshold is 16. Taking Model Stage 0 as an example, each micro batch performs one time of the backward calculation on the four model training devices respectively, after the backward calculation of each micro batch is completed, one accumulation count for the backward gradient is performed, and the count of the counter is incremented by 1, until the count of the counter for completing the backward gradient calculations of the target model block reaches 16. At this point, a value of counter-rank−(Acc_Step//PP−1)*PP*VP is 0, which may be exactly divided by Acc_Step, and the count of the counter is greater than 16 during the first time of the backward calculation of the micro batch of the next model block. It may be determined that this time is the communication timing for the target model block, so the (VP-(counter-rank-(Acc_Step//PP−1)*PP*VPP)//PP)-th model block perform the collective communication, where the (VP-(counter-rank−(Acc_Step//PP−1)*PP*VPP)//PP)-th model block is the target model block at the target sorting position.

(2) Identifying the communication timing of the collective communication based on a second default value

In the embodiments of the present disclosure, the target threshold is set to a specified value, in a case where the default value is determined based on the number of times of the backward gradient calculations, the number of the model stages, and the number of the model blocks contained in each model stage.

For example, the default value determined based on the number of times of the backward gradient calculations, the number of the model stages, and the number of the model blocks contained in each model stage is −(Acc_Step//PP−1)*PP*VP, the target threshold is set to the specified value of 0. Where, Acc_Step represents the number of times of the backward gradient calculations; PP represents the number of the divided model stages; and VP represents the number of the model blocks included in each model stage.

In the embodiments of the present disclosure, determining and setting the default value of the number of times of the backward gradient calculations based on the number of times of the backward gradient calculations, the number of the model stages, and the number of the model blocks contained in each model stage may better adapt to limitations of the model training device, make the model training process more stable, and improve the performance of the model. In addition, setting the target threshold to the specified value may reduce complexity of parameter tuning and improve the efficiency of model training.

In the embodiments of the present disclosure, each model training device sets a counter, with an initial value of counter=−(Acc_Step//PP−1)*PP*VP. When the 1F1B scheduling of VPP is performed, one time backward calculation is performed, 1 is added to a count of the counter, then counter=counter+1.

When a counter of a rank-th calculation device satisfies following conditions, the (VP-(counter-rank)//PP)-th model block is determined as the target model block at the target sorting position, and communication is performed on this model block concurrently with a computation stream.

A condition a in which counter is greater than 0.

A condition b in which counter-rank may be exactly divided by Acc_Step.

In summary, whether in manner (1) or manner (2), the condition b may be understood as determining the difference between the accumulation count with respect to the model stage serial number of the current model training device and the target threshold. In a case where the difference is exactly divided by the target number of times, it is determined that the performing of the integer number of batches of the backward gradient calculations has been completed. In the embodiments of the present disclosure, by combining the difference between the accumulation count and the model stage serial number of the current model training device with the target threshold, the communication timing of the target model block may be flexibly controlled based on the model stage serial number of the current model training device. By determining the completion of the integer number of batches of the backward gradient calculations, the process of model training can be better controlled, thereby saving memory space usage and improving the efficiency of model training.

Moreover, both manner (1) or manner (2) may determine the target model block at the target sorting position based on the accumulation count, the model stage serial number, the target threshold, the number of the divided model stages, and the number of the model blocks contained in each model stage. In the embodiments of the present disclosure, by dynamically determining the target model block, flexible model adjustments may be made according to different sorting targets, and thus needs of different sorting tasks may be satisfied. By determining the target model block as the target model block at the target sorting position and only performing the backward gradient calculation and parameter updates on the target model block, unnecessary calculation and storage overhead may be reduced, and the efficiency of model training may be improved.

For example, when PP is 4, VP is 4, and Acc_Step is 8, the default value is −16, and the target threshold is 0. Explanation is made by taking performing the forward process on data represented by rectangular boxes with dot texture and embedded with arrow shapes by the fourth model block 12 in Model Stage 0 and performing the backward process on data represented by rectangular boxes with grey texture and embedded with droplet shapes by the fourth model block 12 in Model Stage 0 in FIG. 4 as an example. After the target model completes all the backward gradient calculations of the fourth model block in Model Stage 0, the accumulation count of the backward gradients is 4. When the backward propagation process of one mini batch of all the model blocks in Model Stage 0 is completed, the accumulation count of the backward gradient reaches 16, with counter=0. If the counter count reaches the target threshold and the difference between the model stage serial number of the model training device and the target threshold may be exactly divided by the target number of times Acc_Step, the next calculation stage is the communication opportunity for the target model block.

Regardless of whether manner (1) or manner (2) is used, in the embodiments of the

present disclosure, the manner of performing the collective communication may be ALL Reduce, or may be Broadcast, Scatter, Gather, or the like, which is not limited by the present disclosure.

In a case where each model block of the model stage of the current device completes the collective communication, parameter update of the model stage is performed based on an optimizer.

As shown in FIG. 4, in a case where all the four model blocks in the model stage of each model training device have completed the collective communication, there is an optimizer S that updates parameters of the corresponding model stage, and the parameter update is based on the results of the backward gradient calculations. Where the optimizer may use momentum optimizer, adaptive learning rate optimizer, regularization optimizer, or the like, which is not limited by the present disclosure.

In the embodiments of the present disclosure, using the optimizer to update the parameters of the model stage may improve model performance. By adjusting manner and speed of the parameter update, the model can better adapt to training data and optimization objectives.

In the embodiments of the present disclosure, the target model performs at least one of the following tasks:

Natural language processing, visual information processing, multimodal information processing, and protein structure prediction.

In some embodiments, the target model may perform the natural language processing. Firstly, the target model receives a text to be processed, which may be a query, a command, or a statement. The target model will convert the text to be processed which has been preprocessed to a machine understandable representation, typically converting the text to be processed to a text vector representation. According to specific task requirements, the model will perform corresponding operations, for example, completing a question and answer task or a translation task based on text vectors. After the task is completed, the model will generate corresponding an output The output in the question and answer task is an answer, and the output in the translation task is a translation result.

In other embodiments, the target model may perform the visual information processing. Firstly, the target model receives a visual input, such as an image or a video. For the image, the target model will convert it into a computer understandable format, such as a pixel matrix. For the video, the target model will split them into a series of image frames. According to specific task requirements, the model will perform corresponding operations. For example, the target model may perform a classification task or a regression task on the image. After the task is completed, the model will generate a corresponding output. In the classification task, the output of the target model may be a classification label. In the regression task, the output of the target model may be an object detection box. The target model may also complete other perspective information processing tasks, such as outputting an image segmentation result, including the classification and regression tasks.

In other embodiments, the target model may perform the multimodal information processing. The multimodal information processing involves a combination of a plurality of input modalities and a plurality of feature extraction methods. Firstly, the target model receives multimodal inputs such as an image and a text, an image and an audio, or the like. The target model will extract features for each input modality. Once the features of each modality input are extracted, the target model will fuse them and integrate information from different modalities. According to specific task requirements, the target model will perform corresponding operations, such as a multimodal sentiment analysis task of predicting input sentiment categories, and a multimodal question and answer task of answering questions related to the input. After the task is completed, the model will generate a corresponding output. For the classification task, the output may be a classification label. For the question and answer task, the output is an answer, and for the recommendation task, the output is a recommendation result, etc.

In other embodiments, the target model may perform the protein structure prediction. Firstly, the target model receives an amino acid sequence of a protein as input to predict interactions and spatial relationships between amino acids. Based on a sequence prediction result, the target model uses structural modeling techniques to generate an initial structure of the protein. The target model may also use optimization algorithms to adjust conformation of an original structure to minimize energy and satisfy physical constraints.

It should be noted that the target model disclosed in the present disclosure is not limited to the above tasks and application scenarios, and may also be extended to other single modal or multimodal tasks, which may be determined according to actual application scenarios.

In the embodiments of the present disclosure, by performing a plurality kinds of tasks, the model may learn relevant knowledge and connections between different tasks. This knowledge sharing may promote mutual understanding and interaction between different tasks, which helps to improve overall performance and understanding ability of the model.

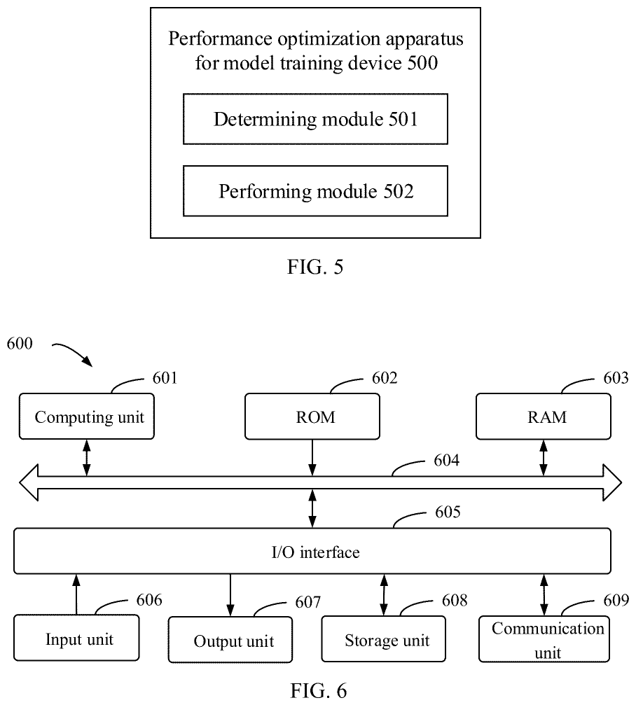

Based on the same technical concept, the embodiments of the present disclosure further provide a performance optimization apparatus for a model training device 500, as shown in FIG. 5, which includes following modules.

A determining module 501 is configured to determine communication timing of a current model training device with respect to a target model block at a target sorting position, so as to be able to perform synchronously collective communication with other model training devices of a plurality of model training devices with respect to model blocks at the target sorting position, where the current model training device is any one training device of the plurality of model training devices; the plurality of model training devices is used for training the same target model; the target model is divided into a plurality of model stages, and each of the plurality of model stages includes a plurality of model blocks arranged in sequence; and during a process of training the target model by using a distributed parallelism strategy, bubbles are generated due to increased calculation time of the model training devices caused by communication operations.

A performing module 502 is configured to perform the collective communication on a backward gradient of the target model block at the communication timing.

In some embodiments, the determining module includes:

A first determining sub module which is configured to determine a next calculation stage as the communication timing of the target model block in a case of satisfying target constraint condition.

The target constraint conditions include:

A number of times of backward gradient calculations of the target model block by the current model training device is greater than or equal to a target number of times;

At the communication timing, backward gradient calculations of a model block at the target sorting position in a first model stage of the plurality of model stages are completed.

In some embodiments, the determining module further includes a second determining sub module which is configured to determine whether the target constraint conditions are satisfied by:

Determining a cumulative amount of the backward gradient to be synchronized for the target model block; and

Determining that the target model block satisfies the target constraint conditions, in a case where the cumulative amount is greater than or equal to the target number of times and it is determined that the model block at the target sorting position in the first model stage of the plurality of model stages can initiate the collective communication.

In some embodiments, the determining module further includes a third determining sub module which is configured to determine whether the target constraint conditions are satisfied by:

Obtaining an accumulation count of the number of times of the backward gradient calculations for the current model training device based on a default value;

Determining that the target model block at the target sorting position satisfies the target constraint conditions, in a case where the accumulation count is greater than or equal to a target threshold and it is determined that an integer number of batches of the backward gradient calculations is completed based on the accumulation count.

The target threshold is determined based on the target number of times, so that the number of times of the backward gradient calculations by the current model training device with respect to the target model block is greater than or equal to the target number of times.

In some embodiments, the determining module further includes a fourth determining sub module which is specifically configured to:

Determine the target threshold based on the number of times of the backward gradient calculations, a number of the model stages, and a number of the model blocks contained in each model stage, when the default value is empty.

In some embodiments, the determining module further includes a fifth determining sub module which is specifically configured to:

Set the target threshold to a specified value, in a case where the default value is determined based on the number of times of the backward gradient calculations, the number of the model stages, and the number of the model blocks contained in each model stage.

In some embodiments, the third determining sub module is specifically configured to:

Determine a difference between the accumulation count with respect to a model stage serial number of the current model training device and the target threshold;

Determine that performing of the integer number of batches of the backward gradient calculations has been completed, in a case where the difference is exactly divided by the target number of times.

In some the third determining sub module is specifically configured to:

Determine the target model block at the target sorting position based on the accumulation count, the model stage serial number, the target threshold, the number of the divided model stages, and the number of the model blocks contained in each model stage.

In some embodiments, the determining module includes:

A sixth determining sub module which is configured to: determine the next calculation stage as the communication timing of the target model block, in response to receiving a synchronization message, the synchronization message is sent by the model training device of the first model stage among the plurality of model stages with respect to the model blocks at the target sorting position. In some embodiments, it further includes:

An updating module which is configured to: update parameters of the model stage based on an optimizer, in a case where each model block of the model stage of the current model training device completes the collective communication.

In some embodiments, the target model performs at least one of the following tasks:

Natural language processing, visual information processing, multimodal information processing, and protein structure prediction.

In some embodiments, the target model adopts a data parallelism strategy in combination of a pipeline parallelism strategy with a 1F1B interleaved scheduling manner, and is divided into a plurality of model stages according to the pipeline parallelism strategy, each model stage is assigned to a corresponding model training device for training.

In the data parallelism strategy, each mini batch of training data is divided into a plurality of micro batches.

Of course, acquisition, storage, and application of user personal information involved in the technical solution of the present disclosure comply with relevant laws and regulations, and do not violate public order and good customs.

Descriptions to specific functions and examples of each module and sub module in the apparatus according to the embodiment of the present disclosure may refer to related descriptions to corresponding steps of the above method embodiments, and will not be repeated here.

According to the embodiment of the present disclosure, the present disclosure further provides an electronic device, a readable storage medium and a computer program product.

FIG. 6 shows a schematic block diagram of an exemplary electronic device 600 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 6, the device 600 includes a computing unit 601 that may perform various appropriate actions and processes according to a computer program stored in a Read-Only

Memory (ROM) 602 or a computer program loaded from a storage unit 608 into a Random Access Memory (RAM) 603. Various programs and data required for an operation of device 600 may also be stored in the RAM 603. The computing unit 601, the ROM 602 and the RAM 603 are connected to each other through a bus 604. The input/output (I/O) interface 605 is also connected to the bus 604.

A plurality of components in the device 600 are connected to the I/O interface 605, and include an input unit 606 such as a keyboard, a mouse, or the like; an output unit 607 such as various types of displays, speakers, or the like; the storage unit 608 such as a magnetic disk, an optical disk, or the like; and a communication unit 609 such as a network card, a modem, a wireless communication transceiver, or the like. The communication unit 609 allows the device 600 to exchange information/data with other devices through a computer network such as the Internet and/or various telecommunication networks.

The computing unit 601 may be various general-purpose and/or special-purpose processing components with processing and computing capabilities. Some examples of the computing unit 601 include, but are not limited to, a Central Processing Unit (CPU), a Graphics

Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 601 performs various methods and processing described above, such as the performance optimization method for the model training device. For example, in some implementation, the performance optimization method for the model training device may be implemented as a computer software program tangibly contained in a computer-readable medium, such as the storage unit 608. In some implementations, a part or all of the computer program may be loaded and/or installed on the device 600 via the ROM 602 and/or the communication unit 609. When the computer program is loaded into RAM 603 and executed by the computing unit 601, one or more steps of the performance optimization method for the model training device described above may be performed. Alternatively, in other implementations, the computing unit 601 may be configured to perform the performance optimization method for the model training device by any other suitable means (e.g., by means of firmware).

Various implements of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of apparatuses may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware component, or in a computing system including a front-end component (e.g., a user computer with a graphical user interface or a web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and the server are generally far away from each other and usually interact with each other through a communication network. A relationship between the client and the server is generated by computer programs running on corresponding computers and having a client-server relationship with each other. The server may be a cloud server, a distributed system server, or a blockchain server.

According to the embodiments of the present disclosure, the electronic device may be integrated with a communication component, a display screen, and an information collection device, or may be set separately from the communication component, the display screen, and the information collection device.

It should be understood that, the steps may be reordered, added or removed by using the various forms of the flows described above. For example, the steps recorded in the present disclosure may be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having skill in the art should understand that, various modifications, combinations, sub-combinations and substitutions may be made according to a design requirement and other factors. Any modification, equivalent replacement, improvement or the like made within the spirit and principle of the present disclosure shall be included in the protection scope of the present disclosure.

What is claimed is:

1. A performance optimization method for a model training device, comprising:
determining communication timing of a current model training device with respect to a target model block at a target sorting position, so as to be able to perform synchronously collective communication with other model training devices of a plurality of model training devices with respect to model blocks at the target sorting position, wherein the current model training device is any one training device of the plurality of model training devices, the plurality of model training devices is used for training a same target model, the target model is divided into a plurality of model stages, each of the plurality of model stages includes a plurality of model blocks arranged in sequence, and during a process of training the target model by using a distributed parallelism strategy, bubbles are generated due to increased calculation time of the model training devices caused by communication operations; and
performing the collective communication on a backward gradient of the target model block at the communication timing.

2. The method of claim 1, wherein determining the communication timing of the current model training device with respect to the target model block at the target sorting position comprises:
determining a next calculation stage as the communication timing of the target model block, in a case of satisfying target constraint conditions,
the target constraint conditions comprise:
a number of times of backward gradient calculations of the target model block by the current model training device is greater than or equal to a target number of times, and
at the communication timing, backward gradient calculations of a model block at the target sorting position in a first model stage of the plurality of model stages are completed.

3. The method of claim 2, wherein determining of satisfying target constraint conditions comprises:
determining a cumulative amount of the backward gradient to be synchronized for the target model block; and
determining that the target model block satisfies the target constraint conditions, in a case where the cumulative amount is greater than or equal to the target number of times and it is determined that the model block at the target sorting position in the first model stage of the plurality of model stages is able to initiate the collective communication.

4. The method of claim 2, wherein determining of satisfying target constraint conditions comprises:
obtaining an accumulation count of the number of times of the backward gradient calculations of the current model training device based on a default value; and
determining that the target model block at the target sorting position satisfies the target constraint conditions, in a case where the accumulation count is greater than or equal to a target threshold and it is determined that an integer number of batches of backward gradient calculations is completed based on the accumulation count,
the target threshold is determined based on the target number of times, so that the number of times of the backward gradient calculations by the current model training device with respect to the target model block is greater than or equal to the target number of times.

5. The method of claim 4, further comprising:
determining the target threshold based on the number of times of the backward gradient calculations, a number of the model stages, and a number of the model blocks contained in each model stage, in a case where the default value is empty.

6. The method of claim 4, further comprising:
setting the target threshold to a specified value, in a case where the default value is determined based on the number of times of the backward gradient calculations, a number of the model stages, and a number of the model blocks contained in each model stage.

7. The method of claim 4, wherein it is determined that the integer number of batches of backward gradient calculations is completed based on the accumulation count, comprising:
determining a difference between the accumulation count with respect to a model stage serial number of the current model training device and the target threshold; and
determining that performing of the integer number of batches of the backward gradient calculations has been completed, in a case where the difference is exactly divided by the target number of times.

8. The method of claim 4, wherein determining the target model block at the target sorting position comprises:
determining the target model block at the target sorting position based on the accumulation count, a model stage serial number, the target threshold, a number of the divided model stages, and a number of the model blocks contained in each model stage.

9. The method of claim 1, wherein determining the communication timing of the current model training device with respect to the target model block at the target sorting position comprises:
determine a next calculation stage as the communication timing of the target model block, in response to receiving a synchronization message, the synchronization message is sent by a model training device of a first model stage among the plurality of model stages with respect to the model blocks at the target sorting position.

10. The method of claim 1, further comprising:
updating parameters of the model stages based on an optimizer, in a case where each model block of the model stage of the current model training device completes the collective communication.

11. The method of claim 1, wherein the target model performs at least one of following tasks:
natural language processing, visual information processing, multimodal information processing, and protein structure prediction.

12. The method of claim 1, wherein the target model adopts a data parallelism strategy in combination of a pipeline parallelism strategy with a 1F1B interleaved scheduling manner, and is divided into the plurality of model stages according to the pipeline parallelism strategy, each model stage is assigned to a corresponding model training device for training, and
in the data parallelism strategy, each mini batch of training data is divided into a plurality of micro batches.

13. An electronic device, comprising:
at least one processor; and
a memory connected in communication with the at least one processor;
wherein the memory stores an instruction executable by the at least one processor, and the instruction, when executed by the at least one processor, enables the at least one processor to execute:
determining communication timing of a current model training device with respect to a target model block at a target sorting position, so as to be able to perform synchronously collective communication with other model training devices of a plurality of model training devices with respect to model blocks at the target sorting position, wherein the current model training device is any one training device of the plurality of model training devices, the plurality of model training devices is used for training a same target model, the target model is divided into a plurality of model stages, each of the plurality of model stages includes a plurality of model blocks arranged in sequence, and during a process of training the target model by using a distributed parallelism strategy, bubbles are generated due to increased calculation time of the model training devices caused by communication operations; and
performing the collective communication on a backward gradient of the target model block at the communication timing.

14. The electronic device of claim 13, wherein determining the communication timing of the current model training device with respect to the target model block at the target sorting position comprises:
determining a next calculation stage as the communication timing of the target model block, in a case of satisfying target constraint conditions,
the target constraint conditions comprise:
a number of times of backward gradient calculations of the target model block by the current model training device is greater than or equal to a target number of times, and
at the communication timing, backward gradient calculations of a model block at the target sorting position in a first model stage of the plurality of model stages are completed.

15. The electronic device of claim 14, wherein determining of satisfying target constraint conditions comprises:
determining a cumulative amount of the backward gradient to be synchronized for the target model block; and
determining that the target model block satisfies the target constraint conditions, in a case where the cumulative amount is greater than or equal to the target number of times and it is determined that the model block at the target sorting position in the first model stage of the plurality of model stages is able to initiate the collective communication.

16. The electronic device of claim 14, wherein determining of satisfying target constraint conditions comprises:
obtaining an accumulation count of the number of times of the backward gradient calculations of the current model training device based on a default value; and
determining that the target model block at the target sorting position satisfies the target constraint conditions, in a case where the accumulation count is greater than or equal to a target threshold and it is determined that an integer number of batches of backward gradient calculations is completed based on the accumulation count,
the target threshold is determined based on the target number of times, so that the number of times of the backward gradient calculations by the current model training device with respect to the target model block is greater than or equal to the target number of times.

17. A non-transitory computer-readable storage medium storing a computer instruction thereon, wherein the computer instruction is used to cause a computer to execute:
determining communication timing of a current model training device with respect to a target model block at a target sorting position, so as to be able to perform synchronously collective communication with other model training devices of a plurality of model training devices with respect to model blocks at the target sorting position, wherein the current model training device is any one training device of the plurality of model training devices, the plurality of model training devices is used for training a same target model, the target model is divided into a plurality of model stages, each of the plurality of model stages includes a plurality of model blocks arranged in sequence, and during a process of training the target model by using a distributed parallelism strategy, bubbles are generated due to increased calculation time of the model training devices caused by communication operations; and
performing the collective communication on a backward gradient of the target model block at the communication timing.

18. The non-transitory computer-readable storage medium of claim 17, wherein determining the communication timing of the current model training device with respect to the target model block at the target sorting position comprises:
determining a next calculation stage as the communication timing of the target model block, in a case of satisfying target constraint conditions,
the target constraint conditions comprise:
a number of times of backward gradient calculations of the target model block by the current model training device is greater than or equal to a target number of times, and
at the communication timing, backward gradient calculations of a model block at the target sorting position in a first model stage of the plurality of model stages are completed.

19. The non-transitory computer-readable storage medium of claim 18, wherein determining of satisfying target constraint conditions comprises:
determining a cumulative amount of the backward gradient to be synchronized for the target model block; and
determining that the target model block satisfies the target constraint conditions, in a case where the cumulative amount is greater than or equal to the target number of times and it is determined that the model block at the target sorting position in the first model stage of the plurality of model stages is able to initiate the collective communication.

20. The non-transitory computer-readable storage medium of claim 18, wherein determining of satisfying target constraint conditions comprises:
obtaining an accumulation count of the number of times of the backward gradient calculations of the current model training device based on a default value; and
determining that the target model block at the target sorting position satisfies the target constraint conditions, in a case where the accumulation count is greater than or equal to a target threshold and it is determined that an integer number of batches of backward gradient calculations is completed based on the accumulation count,
the target threshold is determined based on the target number of times, so that the number of times of the backward gradient calculations by the current model training device with respect to the target model block is greater than or equal to the target number of times.
